(19) United States
(12) Patent Application Publication
(10) Pub. No.: US 2025/0167258 A1
(43) Pub. Date: May 22, 2025

(54) BIPOLAR PLATE FOR AN ELECTROCHEMICAL SYSTEM

(71) Applicant: Reinz-Dichtungs-GmbH, Neu-Ulm (DE)

(72) Inventors: André SPEIDEL, Schwendi (DE); Stephan WENZEL, Pfaffenhofen (DE); Bernd GAUGLER, Ulm (DE)

(21) Appl. No.: 18/954,324

(22) Filed: Nov. 20, 2024

(30) Foreign Application Priority Data
Nov. 21, 2023 (DE) 20 2023 106 851.0
Dec. 13, 2023 (DE) 20 2023 107 360.3
Dec. 21, 2023 (DE) 20 2023 107 593.2

(51) Int. Cl. H01M 8/0258; B23K 26/362; C25B 13/02; C25B 13/05; H01M 8/021; H01M 8/0245; H01M 8/10

(52) U.S. Cl. CPC H01M 8/0258; B23K 26/362; C25B 13/02; C25B 13/05; H01M 8/021; H01M 8/0245; H01M 2008/1095

(57) ABSTRACT

The present disclosure relates to a bipolar plate for an electrochemical system, having a first separator plate and a second separator plate arranged one on top of the other. Each separator plate has, on a side facing away from the other, embossed webs and channels to guide a fluid. The separator plates each have on their mutually facing sides webs and channels to guide a cooling medium along an inner side of the bipolar plate. At least one of the separator plates has structured web regions on at least one side. The structured web regions at least have periodic surface structures with an average spatial period of less than 10 μm. A proportion of the structured web regions of a total web surface is distributed heterogeneously over the total web surface.

### CROSS REFERENCE TO RELATED APPLICATIONS

This application claims priority to German Utility Model Application No. 20 2023 106 851.0, entitled “BIPOLAR PLATE FOR AN ELECTROCHEMICAL SYSTEM”, filed Nov. 21, 2023, and German Utility Model Application No. 20 2023 107 360.3, entitled “BIPOLAR PLATE FOR AN ELECTROCHEMICAL SYSTEM”, filed Dec. 13, 2023, and German Utility Model Application No. 20 2023 107 593.2, entitled “BIPOLAR PLATE FOR AN ELECTROCHEMICAL SYSTEM”, filed Dec. 21, 2023. The entire contents of each of the above-identified applications are hereby incorporated by reference for all purposes.

### TECHNICAL FIELD

The present disclosure relates to a separator plate for an electrochemical system and an electrochemical system comprising at least one such bipolar plate.

### BACKGROUND AND SUMMARY

Known electrochemical systems, for example fuel cell systems or electrochemical compressor systems, redox flow batteries and electrolyzers, usually comprise a large number of bipolar plates arranged in a stack so that every two adjacent bipolar plates enclose an electrochemical cell. The bipolar plates usually comprise two separator plates, which are connected to each other along their rear sides that face away from the electrochemical cells. The bipolar plates can be used, for example, for the electrical contacting of the electrodes of the individual electrochemical cells (e.g. fuel cells) and/or the electrical connection of neighboring cells (series connection of the cells). Particularly in electrolyzers, bipolar plates can also comprise just one separator plate, in which case separate cooling is often not necessary.

The separator plates of the bipolar plates can have channel structures for supplying the cells with one or more media and/or for discharging media. In the case of fuel cells, the media can be, for example, fuels (e.g. hydrogen or methanol), reaction gases (e.g. air or oxygen) or a coolant as supplied media and reaction products and heated coolant as discharged media. Furthermore, the bipolar plates can be used to transport the waste heat generated in the electrochemical cell, for example during the conversion of electrical or chemical energy in a fuel cell, as well as to seal the various media or cooling channels off from each other and/or from the external environment. In the case of fuel cells, the reaction media, i.e. fuel and reaction gases, are normally conducted on the mutually averted surfaces of the individual plates, while the coolant is conducted between the individual plates. The bipolar plates usually have at least one or more through-openings. Through the through-openings, the media and/or the reaction products can be fed to the electrochemical cells bounded by adjacent bipolar plates of the stack, or into the cavity formed by the separator plates of the bipolar plate, or can be discharged from the cells or from the cavity. The electrochemical cells, in particular of a fuel cell, may, for example, each comprise a membrane electrode assembly (or MEA) with a respective polymer electrolyte membrane (PEM) and electrodes. The MEA or the MEA system can also have one or more gas diffusion layers (GDL), which may be oriented towards the separator plates, in particular towards the bipolar plates of fuel cell systems, and are configured as a carbon fleece, for example. In an example fuel cell, hydrogen carried on an anode side is typically converted to water, with oxygen being carried on a cathode side. Protons produced during the oxidation of hydrogen pass from the anode side through the MEA to the cathode, where they react with the oxygen and electrons to form water. The membrane of the fuel cell is electrically insulating and prevents an electrical short circuit between the anode and cathode. The electrons are separately guided from the anode to the cathode so that the electric current can be utilized.

Nowadays, most fuel cell systems are operated with an excess of oxidizing agent. It has been found that the reaction takes place to a greater extent at the points where there is a particularly high concentration of oxidation medium than at other points in the electrochemically active region. This can be the case, for example, in the immediate vicinity of entry points of the oxidizing agent into the electrochemically active region. The stronger conversion of reactants leads to a particularly high current density in the regions where there is a greater excess of oxidizing agent. This results in an uneven distribution of the current density over the active region. A high reactant conversion leads to a high load on the membrane, while the membrane only experiences a low load in regions of low material conversion. Overload regions have a negative effect on the service life of the MEA, that is, its membrane. Low-load regions have the disadvantage of high area-related costs compared to performance, especially as the MEA is a comparatively expensive component. Similar phenomena can occur with PEM electrolyzers, as water is the only medium supplied and an ever-increasing proportion of oxygen is carried along in the water on its way across the bipolar plate, while the actual proportion of water is reduced at the same time. Particularly on a bipolar plate, low load areas may occur towards the end of the water path.

In other electrochemical systems, especially other polymer membrane-based electrochemical systems, other factors can lead to unequal loads on the surface of the polymer membrane.

The object of the present disclosure is therefore to propose an improved bipolar plate and/or an improved electrochemical system, in particular with the aim of increasing a service life of the bipolar plate and/or a service life of an MEA or polymer membrane arranged between bipolar plates in a bipolar plate stack. Additionally or alternatively, the object may be to reduce the costs in relation to the performance of an electrochemical system.

These objects are at least partially solved by the bipolar plate as described herein.

The proposed bipolar plate for an electrochemical system has a first separator plate and a second separator plate, which are arranged on top of each other.

The first separator plate has, on a side that faces away from the second separator plate, embossed webs and channels to guide a first fluid. The second separator plate has, on a side that faces away from the first separator plate, embossed webs and channels to guide a second fluid. The first and second separator plates each have, on their mutually facing sides, webs and channels to guide a cooling medium along an inner side of the bipolar plate.

At least one of the separator plates has structured web regions on at least one side of the separator plate, wherein the structured web regions have at least periodic surface structures with a mean spatial period (Px, Py) of less than 10 μm, wherein a proportion of the structured web regions on the entire web surface is distributed heterogeneously over the entire web surface, for example, only individual portions of the web surface may be structured.

A bipolar plate of this type makes it possible to homogenize the current density without altering the MEA system. This can particularly be used to achieve homogenization of the current density.

The “entire web surface” or “total web surface” can refer to the entire web surface located on one side of the separator plate. Alternatively, the “entire web surface” or “total web surface” may refer to just one region of one side of the separator plate, for example to a region that overlaps with an electrochemically active region of the MEA in orthogonal projection in the stacking direction. Here, the term “first electrochemically active region” is used to designate the region of the first separator plate that overlaps with an electrochemically active region of the MEA, such as the region of the MEA that is surrounded by a reinforcing edge, when the separator plate is arranged in an electrochemical system. Similarly, the term “second electrochemically active region” is used to designate the region of the second separator plate that overlaps with an electrochemically active region of the MEA when the separator plate is arranged in an electrochemical system. It is additionally worth noting that when the present disclosure refers to “overlapping” or to an “overlap” of the first electrochemically active region with the second electrochemically active region, it means an overlap of the regions in an orthogonal projection. One side of a separator plate, which faces away from the other separator plate of the bipolar plate, can be referred to as the gas side. One side of a separator plate, which faces the other separator plate of the bipolar plate, can be referred to as the coolant side. Each separator plate has channels and webs both on their respective gas side, as a side facing the MEA, as well as on the coolant side, as a side facing away from the MEA. Webs on the gas side correspond to channels on the coolant side in orthogonal projection and channels on the gas side correspond to webs on the coolant side in orthogonal projection.

The region that lies centrally between two adjacent channels can be understood as the web region. Structured web region can be understood to mean, for example, that at least 5% and/or at least 10% and/or at least 20% and/or at least 30% and/or at least 40% and/or at least 50% is structured. The structuring in the web region can be arranged symmetrically to the virtual center line, but can also be arranged asymmetrically. It may be advantageous that, when viewed in cross-section, the webs are completely structured between the inflection points, which may represent the delimitation to the adjacent channel, and/or are structured to a maximum of 90% and/or a maximum of 80% and/or a maximum of 70% and/or a maximum of 60% between the inflection points, that is, the web-facing ends of the flanks that extend in an essentially straight line and, in cross-section, contain the inflection point, as described above.

The surface structures may be arranged periodically with respect to one another at least in one spatial direction. The surface structures may also be arranged periodically in two spatial directions relative to one another. According to some embodiments, surface structures may be provided that run parallel to each other, at least partially. The alignment may exist over relatively large or relatively small regions. Optionally, at least within a region enclosed by a grain boundary, the surface structures extend parallel to one another. Different regions containing parallel surface structures, but in which there is a different orientation compared to another region, may also adjoin one another, for example at grain boundaries.

The shape of the structures on the surface thus repeats itself in at least one spatial direction. The spatial period may denote the maximum spacing between two adjacent surface structures of identical or similar shape. For reasons related to production, the surface structures may not be completely identical to one another. Rather, the period may be subject to fluctuations along the surface. An average spatial period is therefore specified, which is less than 10 μm. It may also happen that the spatial period of the surface structures is less than 10 μm in any case. For example, the period lengths of the surface structures can be smaller than 5 μm and/or smaller than 3 μm. Optionally, the average spatial period is a maximum of 2 μm, optionally a maximum of 1.5 μm.

Such periodic surface structures may be created by means of laser radiation from an ultrashort-pulse laser (see below) and are also known in the literature as “Laser-Induced Periodic Surface Structures” (LIPSS). For further explanations, details and definitions regarding LIPSS, reference is made to the following publication:
“Dynamik der Erzeugung und Mechanismen der Entstehung von periodischen Oberflächenstrukturen im Nanometerbereich (LIPSS) durch die Bestrahlung von Festkörpern mit Femtosekunden-Laserpulsen” [“Dynamics of creation and mechanisms of formation of periodic surface structures in the nanometre range (LIPSS) by irradiation of solids with femtosecond laser pulses”], dissertation by Sandra Höhm, Berlin, 2014 (hereinafter: Höhm 2014),
   which is fully incorporated by reference in this disclosure. Thus, the separator plate may be surface-treated by laser in the region of the periodic surface structures. In this case, the spatial period of the surface structures may be directly dependent on the wavelength of the laser light used and may lie in the order of magnitude of the wavelength of the laser light used.

The surface structures may extend, for example, in a wavy or linear manner along their longitudinal direction. In one embodiment, the surface structures may comprise depressions and/or protrusions. The depressions may extend between the protrusions and may be delimited and/or formed by the latter. The depressions or protrusions may at least in sections run essentially parallel to each other (e.g. parallel next to each other). The surface structures may form, at least locally, a trench structure comprising a plurality of elongated depressions which are oriented substantially parallel to one another. The number of surface structures, depressions and/or protrusions can be varied according to requirements. For instance, the number of depressions may depend on the size of the surface that is to have the surface structures. In a region containing similar or identical surface structures, there may be at least 10 or at least 20 trench structures, for example depressions, which at least in sections extend parallel to one another. It is also possible to provide a different number of periods over a certain length in different regions in at least one spatial direction on the surface.

The dimensions of the depressions, for example, the period, may depend at least on the wavelength of the laser radiation used. By way of example, the depressions have a depth of at least 8 nm, optionally at least 20 nm, for example at least 50 nm and/or at most 3 μm, optionally at most 1 μm, optionally at most 500 nm, optionally at most 300 nm, optionally at most 250 nm. The depth is measured normal to the surface formed by the protrusions or normal to the surface of the separator plate that is free of the periodic surface structures. Furthermore, the depressions may have a width of at least 0.1 μm and/or at most 2 μm. The width is measured at half height and perpendicular to the local longitudinal direction of the depressions. The depressions can also have a period in a spatial direction of at least 100 nm, optionally at least 0.3 μm and/or at most 3 μm, optionally at most 1.5 μm, optionally at most 1.2 μm, optionally at most 1000 nm. The periodic surface structures thus may comprise nanostructures having a depth, width and/or period of, in each case, less than one micrometer or, particularly with regard to the period, slightly more than one micrometer.

The surface structures do not serve as fluid guiding structures. That is, they do not form channels on the webs that serve to guide fluid from one channel to the other side of the respective web to another web. On the one hand, the individual structures of the surface structures have only very small flow cross-sections, and on the other hand, they may not extend over the entire web, but may be interrupted at grain boundaries or blocked by depressions.

In one embodiment, the proportion of the structured web regions can be formed on the side of the first separator plate that faces the second separator plate. Additionally or alternatively, the proportion of the structured web regions can be formed on the side of the second separator plate that faces the first separator plate. Additionally or alternatively, the proportion of the structured web regions may be formed on the side of the first separator plate that faces away from the second separator plate and/or the proportion of the structured web regions may be formed on the side of the second separator plate that faces away from the first separator plate. Structured web regions can therefore be formed on one coolant side of the first or the second separator plate. Structured web regions can be formed on the coolant sides of both the first and the second separator plates. Structured web regions can be provided only on an anode side or only on a cathode side or on both gas sides. The proportion of the structured web regions and the unstructured web regions on one side of a separator plate, for example, in an electrochemically active area of the separator plate, can form a pattern. Unstructured web regions can be those web regions that do not have the periodic surface structure described above.

The present disclosure further comprises a bipolar plate for an electrochemical system, with a first separator plate, wherein this first separator plate has, on a first side, embossed webs and channels to guide a first fluid and, on a second side, embossed webs and channels to guide a second fluid. Such an arrangement can be advantageous for electrolyzers, for example, which are often operated without a separate cooling medium, as the supplied water itself cools the system.

In this arrangement, the first separator plate has structured web regions on at least one of its sides. These structured web regions have, at least in sections, periodic surface structures with a mean spatial period (Px, Py) of less than 10 μm. The proportion of the structured web regions in the total web surface is distributed heterogeneously over the entire web surface. For example, only providing the periodic surface structures on the side of the first separator plate facing the second separator plate and/or the side of the second separator plate facing the first separator plate, i.e. only on the inside of the bipolar plate, may reduce corrosion.

The first separator plate may have a first electrochemically active region and the second separator plate may have a second electrochemically active region, wherein the first electrochemically active region and the second electrochemically active region overlap each other and form, in an overlapping region, an active region of the bipolar plate. The second side of the first separator plate can also have a second electrochemically active region. Optionally, the structured web regions may be located in the active region on at least one side of at least one of the separator plates. Optionally, if the structured web regions are only located in the active region of the bipolar plate, the “entire web surface” or “total web surface” may only refer to a region on one side of the separator plate and the web surfaces contained in this region. If, for example, the structured web regions are only arranged on the coolant side of the first separator plate and only in a region that overlaps with the first active region of the MEA, the entire/total web region only relates to the first active region of the coolant side. The proportion of the structured web regions in the entire/total web surface of this region is then distributed heterogeneously over the entire/total web surface of this region, for example.

The heterogeneous distribution can be arranged in such a way that the current density is higher in the region of the structured surfaces, so that a current density distribution across the bipolar plate is more homogeneous than with a corresponding bipolar plate that has no structured surfaces arranged in this way.

In one embodiment, the first separator plate and/or the second separator plate can form at least one contact surface with one another and/or with another component, with the surface structures being formed in the region of the contact surfaces. The other component can be the MEA or the GDL, for example. The surface structures can enable improved electrical conductivity, particularly in the region of the contact surfaces.

The surface structures can be distributed heterogeneously over the contact surfaces.

The first separator plate can have a first region, a second region and possibly a third region in the electrochemically active region of at least one of its sides. The surface structures can be distributed in such a way that a proportion A11, also referred to as first proportion, of the structured web regions in the first region of the total web surface of the first region is smaller than a proportion A12, also referred to as second proportion, of the structured web regions in the second region of the total web surface of the second region and/or that a proportion A13, also referred to as third proportion, of the structured web regions in the third region of the total web surface of the third region is smaller than a proportion A12′ and/or A11′.

Additionally or alternatively, the surface structures can be distributed in such a way that a proportion A11′, also referred to as fourth proportion, of the structured contact surfaces in the first region of the total contact surface of the first region is smaller than a proportion A12′, also referred to as fifth proportion, of the structured contact surfaces in the second region of the total contact surface of the second region and/or that a proportion A13′, also referred to as sixth proportion, of the structured contact surfaces in the third region of the total contact surface of the third region is smaller than a proportion A12′ and/or A11′.

The first, second and third regions can all be located on the gas side and/or all three on the coolant side of the first separator plate.

Additionally or alternatively, the second separator plate may have a first region, a second region and a third region in the electrochemically active region of at least one of its sides. The surface structures can be distributed in such a way that a proportion A21, also referred to as seventh proportion, of the structured web regions in the first region of the total web surface of the first region is smaller than a proportion A22, also referred to as eighth proportion, of the structured web regions in the second region of the total web surface of the second region and/or that a proportion A23, also referred to as ninth proportion, of the structured web regions in the third region of the total web surface of the third region is smaller than a proportion A22 and/or A21. In addition or alternatively, the surface structures can be distributed in such a way that a proportion A21′, also referred to as tenth proportion, of the structured contact surfaces in the first region of the total contact surface of the first region is smaller than a proportion A22′, also referred to as eleventh proportion, of the structured contact surfaces in the second region of the total contact surface of the second region and/or that a proportion A23′, also referred to as twelfth proportion, of the structured contact surfaces in the third region of the total contact surface of the third region is smaller than a proportion A22′ and/or A21′. The first, second and third regions can all be located on the gas side and/or all three on the coolant side of the second separator plate.

A ratio A11/A12 of the first separator plate and/or a ratio A21/A22 of the second separator plate between the proportion A11 or A21 of the structured web regions in the first region and the proportion A12 or A22 of the structured web regions in the second region can be less than 0.9, optionally less than 0.7, optionally less than 0.5.

Additionally or alternatively, a ratio A11′/A12′ of the first separator plate and/or a ratio A21′/A22′ of the second separator plate between the proportion A11′ or A21′ of the structured contact surfaces in the first region and the proportion A12′ or A22′ of the structured contact surfaces in the second region can be less than 0.9, optionally less than 0.7, optionally less than 0.5.

A ratio A13/A12 of the first separator plate and/or a ratio A23/A22 of the second separator plate between the proportion A13 or A23 of the structured web regions in the third region and the proportion A12 or A22 of the structured web regions in the second region can be less than 0.9, optionally less than 0.7, optionally less than 0.5. A ratio A13′/A12′ of the first separator plate and/or a ratio A23′/A22′ of the second separator plate between the proportion A13′ or A23′ of the structured contact surfaces in the third region and the proportion A12′ or A22′ of the structured contact surfaces in the second region can be less than 0.9, optionally less than 0.7, optionally less than 0.5.

An area proportion of the first region and/or of the second region and/or of the third region in the total area of the active region of the bipolar plate can be at least 10%, optionally at least 15%, optionally at least 25%. The first region and the second region and the third region can have the same area. The distribution of the area proportions can vary for both separator plates.

The first separator plate can be formed on at least one of its sides in such a way that a proportion of the structured web regions on the entire web surface and/or a proportion of the structured contact surfaces on the entire contact surfaces of the first and/or second and/or third region of the first electrochemically active region differ from one another by more than 5%, optionally differ from one another by more than 10%, optionally differ from one another by more than 20%. The first and/or the second and/or the third area can be on the coolant side or gas side.

The second separator plate can be configured in such a way that a proportion of the structured web regions on the entire web surface and/or a proportion of the structured contact surfaces on the entire contact surfaces of the first and/or second and/or third region of the second electrochemically active region differ from one another by more than 5%, optionally differ from one another by more than 10%, optionally differ from one another by more than 20%. The first and/or the second and/or the third area can be on the coolant side or gas side.

Different proportions of the regions on the coolant and gas side of at least one of the separator plates are also possible.

In one embodiment, it may be provided that only one of the regions, for example the second region, has the surface structures.

The first separator plate can have a first inlet opening for the supply of the first fluid and a first outlet opening for discharge of the first fluid. The first inlet port can be fluidically connected to the first electrochemically active region via a first inlet region. The first outlet opening can be fluidically connected to the first electrochemically active region via a first outlet region. The first fluid can be passed sequentially through the first inlet region, the first electrochemically active region and the first outlet region.

The second separator plate can have a first inlet opening for supply of the second fluid and a first outlet opening for discharge of the second fluid. The first inlet port can be fluidically connected to the first electrochemically active region via a first inlet region. The first outlet opening can be fluidically connected to the first electrochemically active region via a first outlet region. The first fluid can be passed sequentially through the first inlet region, the first electrochemically active region and the first outlet region.

A flow direction of the first fluid can be inverse to a flow direction of the second fluid, wherein a proportion of the structured web regions and/or the structured contact surfaces of at least one side of a separator plate increases along the flow direction of the first fluid, at least in sections.

The first, the second and the third region can be arranged in one direction of flow. The direction of flow can be a flow direction of a first gas on the first gas side, or a second gas on the second gas side or the coolant. The flow direction of the first gas, the second gas and/or the coolant can differ from one another. The flow direction of the coolant can also be different from at least one gas flow direction. Within any web or a group of webs, the proportion of the structured web regions and/or the contact surfaces can initially increase and then decrease again in the direction of flow. The gradients can be arranged at different points on different webs, relative to the longitudinal extension of the flow field. The increase can also go from a portion without any structuring.

The first separator plate can be a cathode plate and the second separator plate can be an anode plate. The cathode side can, for example, have oxygen-conducting channels, for example, to conduct air or oxygen. The anode side can have hydrogen-conducting channels, for example, to conduct hydrogen, methanol and/or another proton donor.

Alternatively or additionally, the area proportions can vary, depending on the distance from the side edges, in different areas of the flow field.

The surface structures can be spaced apart from an outer edge of the electrochemically active region, whereby a distance between the surface structures and the outer edge can be greater than 2 mm, optionally greater than 5 mm, optionally greater than 8 mm, optionally greater than 10 mm, optionally greater than 15 mm. The surface structures can be spaced apart from an outer edge of the electrochemically active region, whereby at least one channel and/or at least two channels and/or at least four channels and/or at least eight channels and/or at least ten channels can be arranged between the surface structures and the outer edge. The first electrochemically active surface can be surrounded, at least partially, by a first sealing element of the first separator plate and the surface structures can be spaced apart from the first sealing element, wherein a minimum distance between each surface structure and the sealing element can be greater than 5 mm, optionally greater than 8 mm, optionally greater than 10 mm. The sealing element can be configured as an elastomer seal. Additionally or alternatively, the sealing element can be configured as a bead seal. A minimum distance between each surface structure and the sealing element can be greater than 9 mm, optionally greater than 12 mm, optionally greater than 14 mm, especially in the case of a bead seal.

The surface structures can be omitted in peripheral regions of the electrochemically active region, or fewer area proportions with such structures can be provided in such peripheral regions. This can lead to a throttling of the electron flow in these regions. As regions with high current density can be shifted away from these edges towards a region of the active region slightly oriented towards the center, this can serve to protect constructive weak points in the membrane edges.

The present disclosure further relates to an arrangement for an electrochemical system, comprising a bipolar plate according to one of the preceding claims and at least one membrane electrode assembly (MEA) with a frame-shaped reinforcing edge, wherein the MEA and the bipolar plate are arranged resting one on top of the other in a stacking direction and the electrochemically active region of the bipolar plate is enclosed in orthogonal projection in a common plane by the reinforcing edge of the MEA.

A surface structure pattern of the bipolar plate can be spaced from the reinforcing edge in a direction perpendicular to the stacking direction by at least 2 mm, at least 5 mm, at least 8 mm, at least 10 mm or at least 15 mm.

The bipolar plate can be configured to be operated at a specific operating point of an electrochemical system, in particular a fuel cell or an electrolyzer, wherein the specific operating point comprises a specific concentration gradient of the first fluid along the first electrochemically active region. The area proportions of the surface structure can be adapted to the concentration gradient of the first fluid, so that a proportion of the structured web regions and/or structured contact surfaces in portions of the active region with a comparatively low concentration of the first fluid is comparatively large and a proportion of the structured web regions and/or the structured contact surfaces in portions of the active region with a comparatively high concentration of the first fluid is comparatively small.

The proportion of the structured web regions and/or the structured contact surfaces can be adapted accordingly to the concentration gradient of the first fluid, with the adapted proportion of the structured web regions and/or the structured contact surfaces being formed on the gas side or coolant side. Alternatively, the proportion of the structured web regions and/or the structured contact surfaces can also be optimized accordingly to the material flows on both gas sides. The proportion of the structured web regions and/or the structured contact surfaces can then be adapted accordingly to the concentration gradient of the first and second fluids, with the adapted proportion of the structured web regions and/or the structured contact surfaces being formed on the gas side or coolant side of the first and/or second separator plate, for example in each case in the active region. The smallest proportion (including an absence) of the structured web regions and/or the structured contact surfaces can be provided in the regions in which there is an excess of gas from both reaction partners. In the regions where there is a shortage of at least one gas at least near the surface of or in the MEA, a higher proportion of the structured web regions and/or the structured contact surfaces can be provided.

It can be advantageous to achieve a fluid distribution that is as homogeneous as possible across the direction of flow. However, this is not always possible in an optimal way. In this case, it can be advantageous to ensure that the current density and thus the load on the membrane is as uniform as possible by adapting the arrangement of the surface structures.

The regions provided with the surface structures may be provided with a coating, at least in sections, for example with a coating that increases the electrical conductivity.

In one embodiment, the bipolar plate can have regions in which, in an orthogonal projection, coated surfaces of one separator plate overlap with structured surfaces of the other separator plate. The structured surfaces can be designated as UKP (ultra-short pulse laser treated) surfaces. The bipolar plate can have regions in which at least one separator plate has the periodic surface structure and coating as described above.

The coating may contain one or more of the following substances or may consist of one or more of these substances or alloys thereof: electrically conductive oxides, carbon, electrically conductive carbon layers, precious metals such as Au, Ag or Pt, metals such as Ti, Zr, Nb, Ta or Cr, metal nitrides or metal oxynitrides such as TIN, TION (with varying oxygen/nitrogen ratio), CrN, Cr₂N, metal carbides, metal borides, metal silicides and/or silicon carbide. The coating can be single or multi-layered. The coating can be applied unevenly over at least one side of one or both separator plates. The coating can be applied directly to the structured web regions or partly to structured web regions and partly to unstructured web regions. The coating can additionally or alternatively be applied in channel structures.

The present disclosure further relates to a method of manufacturing a bipolar plate, as described above. The method comprises the steps:
Providing a first separator plate and a second separator plate,
Irradiating the first and/or second separator plate by means of a pulsed laser, wherein a pulse duration of the laser pulses is less than 1 ns, optionally less than 100 ps,
Creating periodic surface structures on the separator plate using the laser radiation,
whereby a proportion of the structured web regions in the total web region is distributed heterogeneously over the entire web surface.

A coating can also be applied, for example in the areas with periodic surface structures.

The features described in relation to the bipolar plate as described above can be transferred to the method.

The said plurality of periodic surface structures can be generated within a spatially contiguous projection of the respective laser pulse onto the separator plate. A plurality of periodic surface structures can be created per laser pulse. The creation of each periodic surface structure by the respective laser pulse can be completed before the next laser pulse hits. At least 5 or at least 10 or at least 20 periodic surface structures, for example trench structures, can be created per laser pulse. The periodic surface structures are thus created by each laser pulse within the contiguous surface irradiated by the respective laser pulse and not, for example, by the separator plate being scanned in a spatially periodic manner or being irradiated with a spatially periodic, non-contiguous light pattern, such as a diffraction pattern or interference pattern.

It is important here that the laser pulses have a pulse duration of less than 1 ns, optionally less than 100 ps, optionally less than 10 ps, or optionally less than 1 ps. The laser pulses may have a pulse frequency of 1 MHz or less. Optionally, it may be advantageous if the ratio of pulse frequency to pulse duration is at least 1000. Due to this short pulse duration and the low pulse frequency in comparison thereto, on the one hand very high intensities can be achieved, which may be required in order to ablate the surface and/or rearrange the surface material. On the other hand, the short pulse duration in conjunction with the considerable dead times enables the surface material to be machined in a manner largely free of heat diffusion, and thus makes it possible to create the periodic surface structures.

In some embodiments, the pulse duration is less than 100 ps, less than 50 ps, less than 20 ps, less than 10 ps, or even less than 1 ps. In some embodiments, pulse durations in the fs region are used, for example greater than 30 fs and/or less than 1000 fs and/or less than 500 fs, optionally greater than 50 fs and/or greater than 100 fs. Picosecond or femtosecond lasers can be used for the method, these being referred to collectively as ultrashort-pulse lasers.

The present disclosure further comprises an electrochemical system comprising multiple bipolar plates as described above.

Examples of embodiments of the bipolar plate are shown in the figures and are explained in more detail in the description below.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows a cross-section of an electrochemical system comprising a plurality of separator plates or bipolar plates arranged in a stack.

FIG. 3A schematically shows a perspective view of two bipolar plates of the system according to FIG. 1 with a membrane electrode assembly (MEA) arranged between the bipolar plates using the example of a fuel cell system.

FIG. 3B schematically shows a cross-section through a plate stack in a system of the type shown in FIG. 1.

FIG. 4 schematically shows a plan view of a bipolar plate with evenly distributed welds according to the prior art.

FIG. 5 schematically shows a plan view of an example bipolar plate with structured web regions, whereby a proportion of the structured web regions in the entire web surface is distributed heterogeneously over the entire web surface.

FIG. 6 schematically shows a plan view of another example bipolar plate with an unevenly distributed proportion of the structured web regions on the entire web surface.

FIG. 7 schematically shows a plan view of another example bipolar plate with an unevenly distributed proportion of the structured web regions on the entire web surface.

FIG. 8 schematically shows a plan view of another example bipolar plate with an unevenly distributed proportion of the structured web regions on the entire web surface.

FIG. 9 schematically shows a plan view of another example bipolar plate with an unevenly distributed proportion of the structured web regions on the entire web surface.

FIG. 10 schematically shows a plan view of another example bipolar plate with an unevenly distributed proportion of the structured web regions on the entire web surface.

FIG. 11 schematically shows a plan view of another example bipolar plate with an unevenly distributed proportion of the structured web regions on the entire web surface.

FIG. 12 schematically shows a plan view of another example bipolar plate with an unevenly distributed proportion of the structured web regions on the entire web surface.

FIG. 13 schematically shows a perspective view of a portion of a separator plate.

FIG. 14 shows a microscopic image of periodic surface structures in plan view.

FIG. 15 shows an enlarged view of Detail A of FIG. 13.

FIG. 16 shows an enlarged view of Detail B of FIG. 13.

FIG. 17 shows a plan view of the portion of the separator plate shown in FIG. 13.

FIG. 18 shows another microscopic image of periodic surface structures in plan view.

FIG. 19 shows an example cross-sectional view of a bipolar plate with an MEA attached to it.

FIG. 20 shows an enlarged view of a portion of FIG. 19.

FIG. 21 shows another example cross-sectional view of a bipolar plate with an MEA attached to it.

### DETAILED DESCRIPTION

Here and below, features that recur in different figures are denoted in each case by the same or similar reference signs.

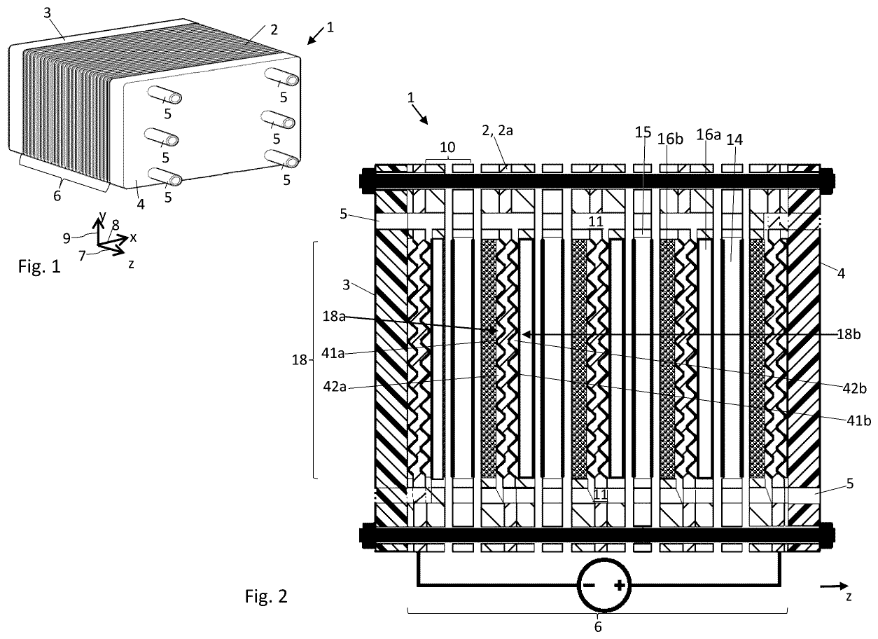

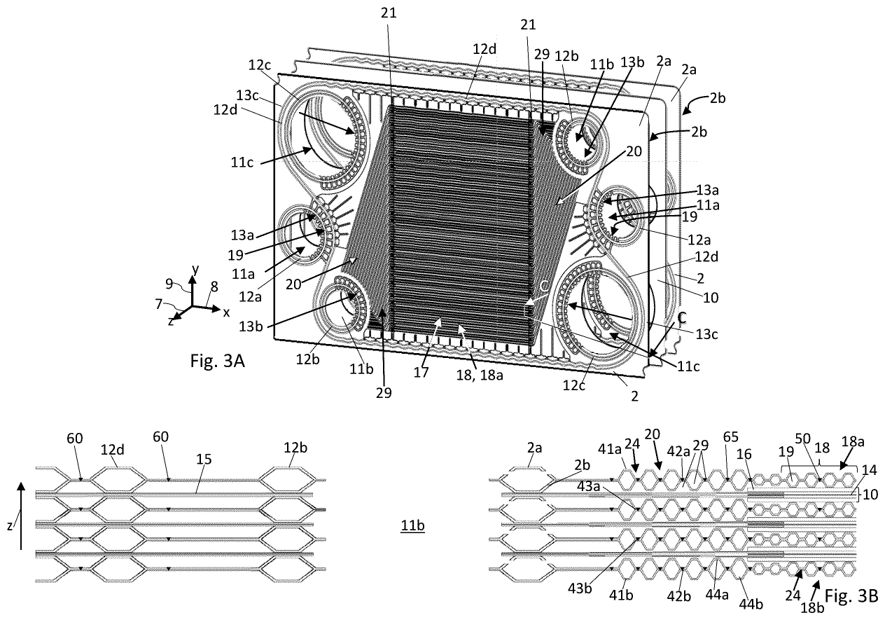

FIG. 1 shows an electrochemical system 1 with a plurality of identically constructed metallic bipolar plates 2 which are arranged in a stack 6 and are stacked along a z-direction 7. The bipolar plates 2 of the stack 6 are clamped between two end plates 3, 4. The z-direction 7 is also called the stacking direction. In the present example, the system 1 is a fuel cell stack. In each case two adjacent bipolar plates 2 of the stack enclose between them an electrochemical cell which serves, for example, for conversion of chemical energy into electrical energy. To form the electrochemical cells of system 1, a membrane electrode assembly (MEA) is arranged between adjacent bipolar plates 2 of the stack (see e.g. FIG. 3A). The MEAs typically each contain at least one membrane, e.g. an electrolyte membrane. Furthermore, a gas diffusion layer (GDL) can be arranged on one or both surfaces of the MEA, not shown in FIGS. 1 and 3A but shown in FIG. 2.

In alternative embodiments, the system 1 may equally be in the form of an electrolyzer, an electrochemical compressor or a redox flow battery. Bipolar plates can likewise be used in these electrochemical systems. The structure of these bipolar plates can then correspond to the structure of the bipolar plates 2 described in more detail here, even if the media fed onto or through the bipolar plate in an electrolyzer, in an electrochemical compressor or in a redox flow battery may differ in each case from the media used for a fuel cell system.

The z-axis 7, together with an x-axis 8 and a y-axis 9, spans a right-handed Cartesian coordinate system. The bipolar plates 2 each define a plate plane, whereby the plate planes of the separator plates 2a, 2b are each aligned parallel to the x-y plane and thus perpendicular to the stacking direction or to the z-axis 7. The end plate 4 comprises multiple media connections 5, via which media can be fed into the system 1 and via which media can be discharged from the system 1. These media, which can be fed into the system 1 and which can be discharged from the system 1, may comprise, for example, fuels such as molecular hydrogen or methanol, reaction gases such as air or oxygen, reaction products such as water vapor, or depleted fuels or coolants such as water and/or glycol.

FIG. 2 shows a cross-section of an electrochemical system 1 with multiple separator plates 2a arranged in a stack, which, in the example shown from a PEM electrolyzer, also form the only layer of the bipolar plates 2. The structure of the membrane electrode assembly (MEA) 10 differs from that in fuel cells in that instead of two essentially identical or mirror-inverted gas diffusion layers (GDLs) 16 on either side of the membrane 14, a GDL 16a, usually made of graphite fleece, is combined with a so-called porous transport layer (PTL) 16b, which is usually made of sintered titanium material, on the opposite side of the membrane 14. For the sake of simplicity, a PTL is also subsumed under the term GDL in this document. The media ports 5 are also designed slightly differently, namely without any protruding elements but, in their basic function, are comparable to the media ports 5 in FIG. 1. A PEM electrolyzer, however, does not usually require a separate coolant, which means that it is not only unnecessary to provide the cavity for guiding the coolant within a bipolar plate, but also that there are less media ports 5 and through-openings 11.

FIG. 3A shows a perspective view of two adjacent bipolar plates 2 in an electrochemical system of the type of system 1 of FIG. 1 and a membrane electrode assembly (MEA) 10, as known from the prior art, arranged between these adjacent bipolar plates 2, the MEA 10 in FIG. 3A being largely concealed by the bipolar plate 2 facing the viewer. The bipolar plate 2 is formed from two separator plates 2a, 2b joined together in a material bond (see e.g. FIG. 3B), of which only the first separator plate 2a facing the viewer is visible in FIG. 3A, concealing the second separator plate 2b. The separator plates 2a, 2b may each be manufactured from a metal sheet, for example from a stainless-steel sheet. The separator plates 2a, 2b may for example be welded to one another, for example by laser welds. On one side the separator plates 2a, 2b can be tightly welded to each other along and at a distance from their outer edges, that is, at least along the inner edge of a part of the through-openings along sealing seams 60, for example outside and/or inside the perimeter bead 12d. Further weld seams are possible.

The separator plates 2a, 2b have through-openings, which are aligned with each other and form through-openings 11a-c of the bipolar plate 2. When a plurality of bipolar plates of the same type as the bipolar plate 2 are stacked, the through-openings 11a-c form ducts which extend through the stack 6 in the stacking direction 7 (see FIG. 1). Typically, each of the ducts formed by the through-openings 11a-c is fluidically connected to one of the media ports 5 in the end plate 4 of the system 1. By way of the ducts formed by the through-openings 11a, it is possible for e.g. coolant to be supplied to the stack or discharged from the stack. By contrast, the ducts formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are substantially parallel to the plate plane.

In order to seal off the through-openings 11a-c with respect to the interior of the stack 6 and with respect to the surrounding environment, the first separator plates 2a may each have sealing arrangements in the form of sealing beads 12a-c, which are arranged in each case around the through-openings 11a-c and in each case completely surround the through-openings 11a-c. The second separator plates 2b have corresponding sealing beads to seal the through-openings 11a-c on the rear side of the separator plates 2 that face away from the viewer of FIG. 3A (not shown). Alternatively, elastomer seals can also be used.

On their outer side facing the viewer of FIG. 3, in an electrochemically active region 18, the first separator plates 2a have a flow field 17 with structures for guiding a reaction medium along the outer side of the separator plate 2a. These structures are illustrated in FIG. 3A by a plurality of webs 41 and channels 42 extending between the webs and delimited by the webs. On the outer side of the bipolar plates 2 that faces the viewer of FIG. 3A, the first separator plates 2a also each have a distribution and collection region 20. Distribution or collection regions 20 each comprise structures that are designed to distribute a medium introduced into the distribution region 20 from a first of the two through-openings 11b over the active region 18, or to collect or bundle a medium flowing from the active region 18 to the second of the through-openings 11b. In FIG. 3A, the fluid-guiding structures 29 of both distribution or collection regions 20 are also provided by webs and channels extending between the webs and delimited by the webs. In the following text, only the distribution region 20 will be discussed for the sake of simplicity; the corresponding statements can equally apply to a collection region 20. Similarly, the distribution region is sometimes referred to as inlet region 20 and the collection region is sometimes referred to as outlet region 20.

The sealing beads 12a-12c have passages 13a-13c, of which the passages 13a are formed both on the underside of the upper separator plate 2a and on the upper side of the lower separator plate 2b, while the passages 13b are formed in the upper separator plate 2a and the passages 13c in the lower separator plate 2b. For example, the passages 13a, which are designed as localized elevations of the bead, in particular of their feet and parts of their flanks, allow coolant to pass between the through-opening 12a and the distribution region 20, so that the coolant enters the distribution region between the bipolar plates or is led out of the collection region 20. Furthermore, the passages 13b allow a passage of hydrogen between the through-opening 12b and the distribution region on the upper side of the separator plate 2a that is on top, these passages 13b are characterized by perforations facing the distribution region and running at an angle to the plate plane. For example, hydrogen flows through the passages 13b from the through-opening 12b to the distribution region on the top of the separator plate 2a or in the opposite direction from the collection region. The passages 13c allow passage of, for example, air between the through-opening 12c and the distribution region, so that air enters the distribution region on the underside of the separator plate 2b that is lying underneath or is led out of the collection region. The associated perforations are not visible here.

The first separator plates 2a also each have a further sealing arrangement in the form of a perimeter bead 12d, which surrounds the flow field 17 of the active region 18, the distribution and collection areas 20 and the through-openings 11b, 11c and seals these off from the through-opening 11a, i.e. from the coolant circuit, and from the external environment of the system 1. The second separator plates 2b each comprise corresponding perimeter beads. The structures of the active region 18, the distribution structures of the distribution and collection region 20 and the sealing beads 12a-d are each formed integrally with the separator plates 2a and molded into the separator plates 2a, e.g. in an embossing or deep-drawing process or via hydroforming. The same applies to the corresponding structures of the second separator plates 2b.

The two through-openings 11b or the ducts formed by the through-openings 11b through the plate stack of the system 1 are in fluid connection with each other via passages 13b in the sealing beads 12b, via the distribution structures of the distribution or collection region 20 and via the flow field 17 in the active region 18 of the first separator plates 2a facing the viewer of FIG. 3A. Similarly, the two through-openings 11c or the ducts formed by the through-openings 11c are in fluid connection with each other through the plate stack of the system 1 in each case via corresponding bead passages, via corresponding distribution and collection structures and via a corresponding flow field on an outer side of the second separator plates 2b facing away from the viewer in FIG. 3A. In contrast, the through-openings 11a or the ducts through the plate stack of the system 1 that are formed by the through-openings 11a are each fluidically connected to one another via a cavity 19 that is enclosed or surrounded by the separator plates 2a, 2b. Each cavity 19 serves to guide a coolant through the bipolar plate 2, for example to cool the electrochemically active region 18 of the bipolar plate 2.

The bipolar plate 2 is formed from two individual plates, namely separator plates 2a, 2b, which are joined together with a material bond (see e.g. FIG. 3B), of which only the first individual plate facing the viewer is visible in FIG. 3A, concealing the second individual plate. The individual plates may each be formed of a shaped metal sheet, for example a stamped or deep-drawn stainless-steel sheet. This metal sheet may have, for example, a thickness of at most 150 μm, optionally at most 100 μm, optionally at most 90 μm, optionally at most 80 μm. The individual plates may be welded to one another, for example by laser-welded joints.

FIG. 3B schematically shows a cross-section through a portion of the plate stack 6 of system 1 from FIG. 1, with the sectional plane aligned in the z-direction and thus perpendicular to the plate planes of the bipolar plates 2. In FIG. 3B, the sectional plane runs along a bent section, along the sectional line C-C in FIG. 3A.

The identically constructed bipolar plates 2 of the stack each comprise the first metallic separator plate 2a previously described and the second metallic separator plate 2b previously described. Structures for guiding media along the outer surfaces of the separator plates 2, for example in each case in the form of webs and channels delimited by the webs, are apparent. In particular, channels are shown on the surfaces of adjoining separator plates 2a, 2b directed away from one other, as well as cooling channels in the cavity 19 between adjacent separator plates 2a, 2b. Adjacent to the sealing bead 12d and between the cooling channels both in the distribution or collection region 20 and in the active region 18, the two separator plates 2a, 2b rest on top of each other in a contact region 24 and are connected to each other there, in the present example by means of laser weld seams 60, 70, 50.

A respective membrane electrode assembly (MEA) 10 known for example from the prior art is arranged between adjacent separator plates 2 of the stack. The MEA 10 typically comprises a membrane, e.g. an electrolyte membrane, and an edge portion 15 connected to the membrane 14. For example, the edge portion 15 can be bonded to the membrane 14, e.g. by an adhesive connection or by lamination.

In the present case, the term “electrochemically active region” is used to designate the respective region of the separator plates 2a, 2b that is opposite an electrochemically active region of a MEA 10 when the separator plate 2a, 2b is arranged in an electrochemical system. The membrane of the MEA 10 extends in each case at least over the active region 18 of the adjacent separator plates 2a, 2b and enables a proton transfer there through the membrane 14. The actual active region 18 is delimited by the edge portion 15 of the MEA. This means that the membrane does not extend into the distribution or collection region 20. The edge portion 15 of the MEA 10 serves in each case for positioning, fastening and sealing the membrane between the adjoining separator plates 2.

The edge portion 15 in each case covers the distribution or collection region 20 of the adjoining bipolar plates 2. Outwards, the edge portion 15 can also extend beyond the perimeter bead 12d and adjoin or protrude beyond the outer edge area of the separator plates 2a, 2b (see FIG. 3A).

Furthermore, gas diffusion layers 16 may be arranged additionally in the active region 18. The gas diffusion layers 16 enable direct flow of gas to the membrane over the greatest possible region of the surface of the membrane and can thus improve the transfer of protons via the membrane. The gas diffusion layers 16 can, for example, be arranged on both sides of the membrane at least in the active region 18 between the adjacent bipolar plates 2. The gas diffusion layers 16 may be, for example, formed from a fiber fleece or comprise a fiber fleece.

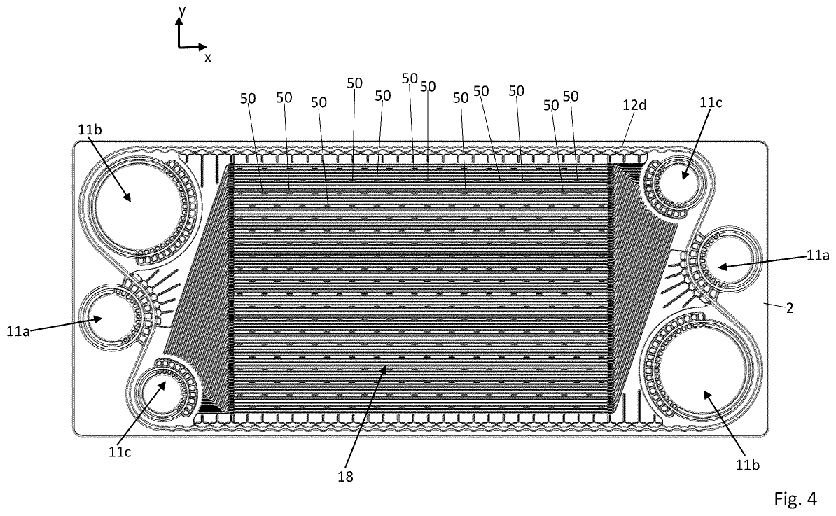

FIG. 4 shows a plan view of a bipolar plate 2 of an electrochemical system of the type of system 1 in FIG. 1. The bipolar plate has a plurality of welds 50, only some of which are marked with reference symbols for the sake of clarity. The plurality of welds 50 results in a weld pattern. In the prior art, the welds 50 are homogeneous, i.e. evenly distributed over the active region 18 of the bipolar plate 2 of FIG. 4. Such a bipolar plate can have the disadvantage that a current density during operation of the bipolar plate is heterogeneously distributed over the active region due to the natural gradients of the reaction gases. This can lead to overload regions and thus a reduced service life of the MEA or its membrane and/or low-load regions with reduced performance.

In contrast, the present disclosure provides that at least one of the separator plates 2a, 2b has structured web regions 80 on at least one side of the separator plate 2a, 2b, wherein the structured web regions 80 have at least periodic surface structures 38 with an average spatial period (Px, Py) of less than 10 μm. A proportion of the structured web regions 80 in the total web area is distributed heterogeneously over the entire web region, as shown in the examples of FIGS. 5 to 12. The examples in FIGS. 5 to 12 are merely exemplary in nature.

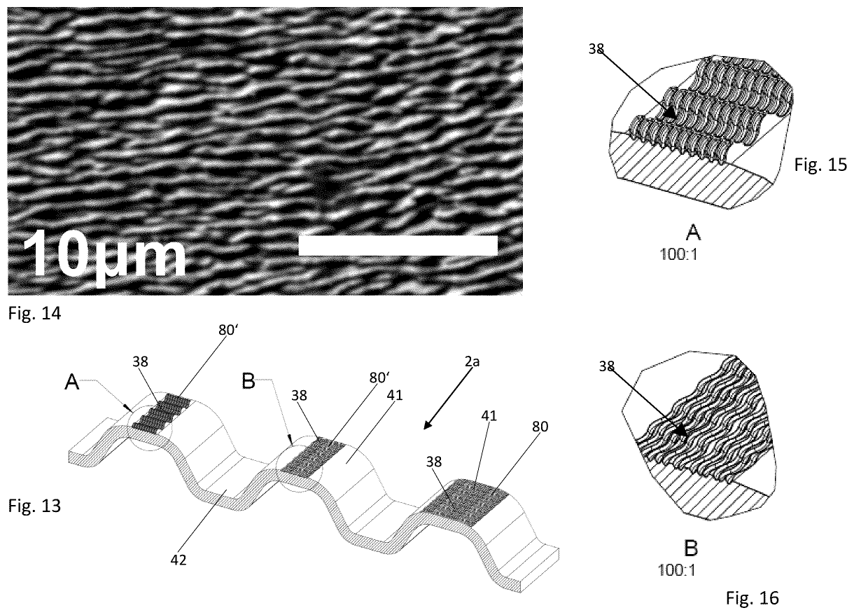

FIGS. 5 to 12 each show plan views of a bipolar plate 2 in an electrochemical system. The representation can correspond both to a representation of a gas side of a first separator plate 2a and to a gas side of a second separator plate 2b. It is possible that only one of the separator plates 2a, 2b has one of the configurations shown, or both separator plates, in which case examples from different figures can also be combined. The description here refers to the structured web regions 80; the same can apply to the structured contact surfaces 80′; the difference between the two is explained below, in particular in the context of FIG. 13. The reference sign 80 in the figures is only partially, together with the surface-structured portions 81-84, seen in the figures, even if a surface structure texturing 38 is always present in these portions.

FIG. 5 shows a plan view of a bipolar plate 2 of an electrochemical system of the type of system 1 in FIG. 1 or FIG. 2. In the image plane shown, the first fluid flows from left to right. The active region 18 is delimited by its outer edge 18′. There are portions 70 in the active region where the web regions and thus the contact surfaces are unstructured. The portions in which structured web regions 80 with the above-mentioned periodic surface structures 38 are present are hatched and are differently distributed over the active region 18. In a first region I, only a short section 81 is present when viewed in the direction of flow, in which structured web regions 80 are present with the above-mentioned periodic surface structures 38. In a second region II, the surface structures 38 are arranged evenly on the webs in two sections 82, 83, again shown hatched. In a third region III, the surface structures 38 are arranged uniformly on the webs in a region 84 shown hatched. The first region I and the second region II have the same area as the third region III. A proportion of the section 81 in the total web surface of the first region I is less than a proportion of the sections 82 and 83 in the total web surface of the second region II and is less than a proportion of the region 84 in the total web surface of the third region III. The structured web regions 80 are distributed heterogeneously over the entire web surface. The structured web regions 80 are spaced from an outer edge 18′ of the active region 18, here a circumferential portion 71 is formed, in which the web regions are formed without the surface structuring 38.

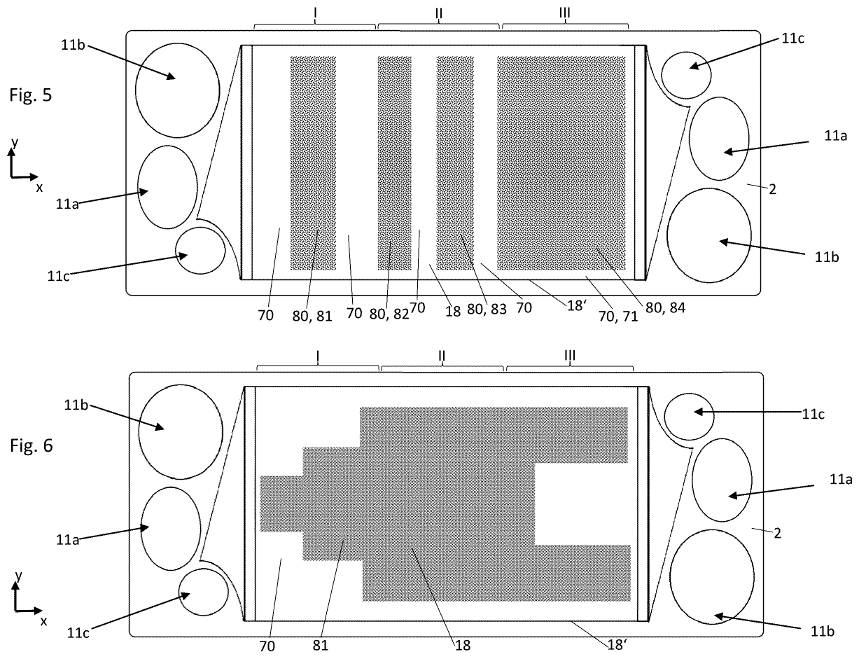

FIG. 6 shows a top view of a bipolar plate 2 of an electrochemical system of the type of system 1 in FIG. 1 or FIG. 2. In the image plane shown, the first fluid flows from left to right. The active region 18 is delimited by its outer edge 18′, which is adjoined by a circumferential portion 71 in which the web regions are formed without any surface structuring 38. 70 indicates further portions in which the web regions are formed without the surface structuring 38. In a section 81 shown hatched, the surface structures 38 of the type described above are uniformly arranged on the webs. Portion 81 extends from left to right, i.e. in the x-direction, and is <-shaped. In regions where the surface structures 38 are provided, electrical conductivity is improved. Again, three regions I, II and III are shown. The surface structures are distributed here in such a way that a proportion of the structured web regions 80 in the first region I in the total web surface of the first region I is smaller than a proportion of the structured web regions 80 in the second region II in the total web surface of the second region II. Furthermore, a proportion of the structured web regions 80 in the third region III of the total web surface of the third region III is also significantly smaller, at less than 50%, than a proportion in the second region II and slightly smaller than a proportion in the first region I. Due to the heterogeneous distribution of the proportion of structured web regions 80 in the total web surface over the entire web surface of the active region 18, a more homogeneous current density can be achieved.

The embodiments of FIGS. 5 and 6 may be particularly suitable if one medium strongly dominates the current density distribution and its distribution relative to the center line of the plate is essentially mirror-symmetrical in the direction of flow of this fluid.

FIG. 7 shows a plan view of another example of a schematically illustrated bipolar plate 2 in an electrochemical system of the type of system 1 in FIG. 1 or FIG. 2. Arrow A marks a concentration gradient of the fluid, which is directed from the through-hole 11c (bottom left in FIG. 7) via the distribution region into the active region 18 and on to the through-hole 11c (top right in FIG. 7). The active region 18 is delimited by its outer edge 18′. In a section 81 shown hatched, the surface structures 38 of the type described above are arranged evenly on the webs. In FIG. 7, the portion 81 extends from the top left of the active region 18 in the shape of a staircase on both sides to the bottom right of the active region 18. The surface structures 38 are spaced apart from the edge of the active region 18′, both in the corresponding portions 71 and in the portions 70 the web regions are formed without any surface structuring 38.

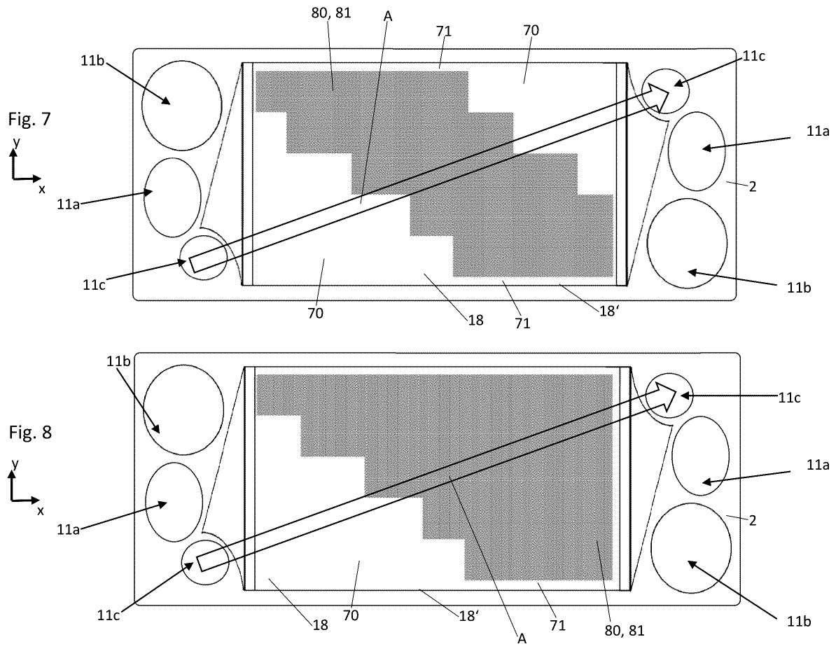

FIG. 8 shows a plan view of another example of a schematically depicted bipolar plate 2 in an electrochemical system of the type of system 1 in FIG. 1 or FIG. 2. Arrow A indicates a concentration gradient of the fluid, which is directed from the through-hole 11c (bottom left in FIG. 8) via the distribution region into the active region 18 and on to the through-hole 11c (top right in FIG. 8). The active region 18 is delimited by its outer edge 18′. In a section 81 shown hatched, the surface structures 38 of the type described above are arranged evenly on the webs. In FIG. 8, the section 81 extends from the top left of the active region 18 in the shape of a staircase almost to the outer right edge of the active region 18. The surface structures 38 are spaced from the edge of the active region 18′.

The embodiments of FIG. 8 may be particularly suitable if one medium strongly dominates the current density distribution and the medium is supplied and discharged off-center, i.e. a large part of the medium has an approximately diagonal course or a course parallel to the diagonal. The embodiment shown later in FIG. 12 also shows the advantages of the medium taking this course.

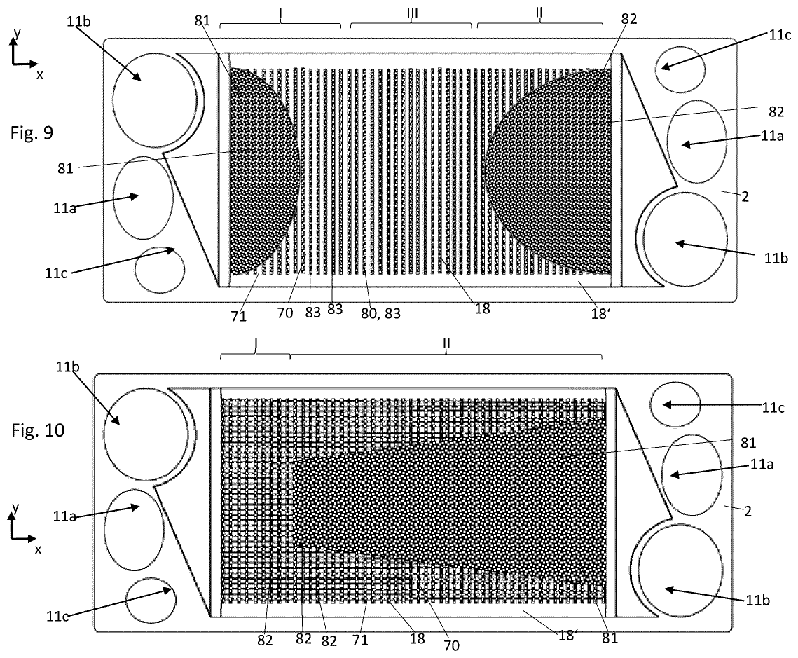

FIG. 9 shows a plan view of another example of a schematically depicted bipolar plate 2 in an electrochemical system of the type of system 1 in FIG. 1 or FIG. 2. The active region 18 is delimited by its outer edge 18′. In sections 81, 82, 83, the surface structures 38 of the type described above are arranged evenly on the webs. The webs of the intermediate sections 70, shown in white, do not have any such surface structures 38. The portion 81 in FIG. 9 is shaped like an elongated semicircle and is arranged on the left in the active region 18 in FIG. 9. The portion 82 in FIG. 9 is shaped like a compressed semicircle and is arranged in the active region 18 on the right in FIG. 9. Strip-shaped portions 83, of which, for the sake of clarity, only some are indicated with reference number 83, extend essentially parallel to the y-axis and are arranged between the portions 81 and 82. The surface structures 38 are spaced from the upper and lower edges 18′ of the active region. Regions I, II and III are again marked, but the sequence from left to right is I, III and II; the third region III has the smallest proportion of web regions with surface structuring 38. Here, the second region II is arranged closer to the outlet opening 11 than the first region I and the third region III.

FIG. 10 shows a plan view of another example of a schematically depicted bipolar plate 2 in an electrochemical system of the type of system 1 in FIG. 1 or FIG. 2. The active region 18 is delimited by its outer edge 18′. In portions 81, 82, the surface structures 38 of the type described above are arranged evenly on the webs. The webs of the intermediate sections 70, shown in white, do not have any such surface structures 38. The portion 81 in FIG. 10 is shaped like a trapezoid extending centrally from right to left over approximately three quarters of the active region 18. Strip-shaped portions 82, only some of which are indicated with the reference sign 82 for the sake of clarity, extend essentially parallel to the y-axis and are arranged essentially over the entire active region, spaced apart from the lateral edges 18′ of the active region 18. The surface structures 38 are also spaced from the upper and lower edges 18′ of the active region 18. The left-hand region, in which only the strip-shaped sections 82 with surface structures 38 are provided, can here be considered the first area I, the right-hand region, in which both strip-shaped sections 82 and the trapezoidal section 81 with surface structures 38 are provided, can here be considered the second region II. This means that there do not always have to be three regions I, II, III, and the areal extent of these regions can also vary.

Similarly to FIGS. 5 and 6, the embodiment of FIG. 10 may be particularly suitable if one medium strongly dominates the current density distribution and its distribution relative to the center line of the plate is essentially mirror-symmetrical in the flow direction of this fluid.

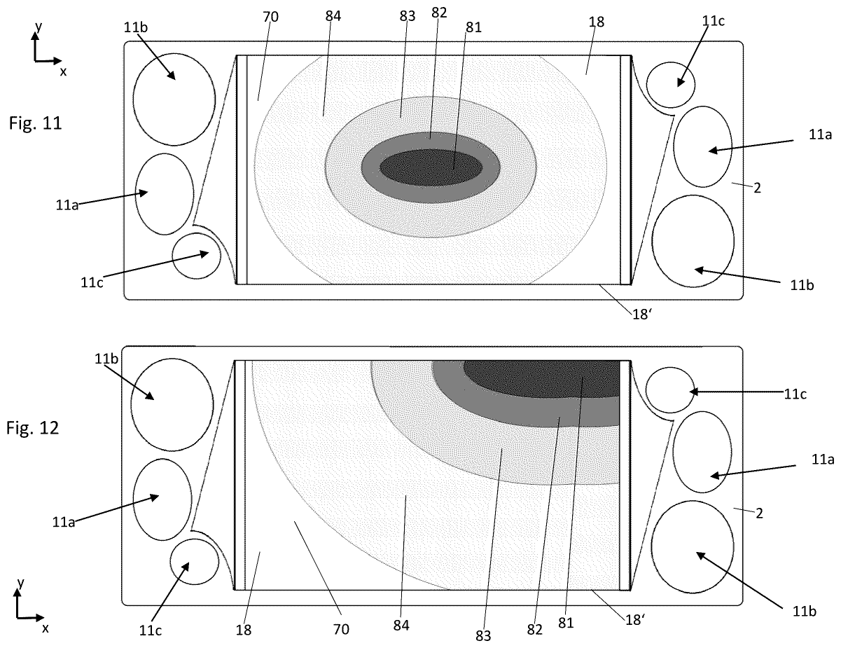

FIGS. 11 and 12 each show a plan view of another example of a schematically depicted bipolar plate 2 of an electrochemical system of the type of system 1 in FIG. 1 or FIG. 2. The active region 18 is delimited by its outer edge 18′. In sections 81, 82, 83, 84, the surface structures 38 of the type described above are arranged on the webs, section 70 is again free from any surface structures 38. The surface structures 38 are evenly arranged in each of the portions 81, 82, 83, 84. A proportion of the structured web surfaces in section 81 of the total web surfaces of section 81 is greater than a proportion of the structured web surfaces in section 82 of the total web surfaces of region 82. A proportion of the structured web surfaces in section 82 of the total web surfaces of section 82 is greater than a proportion of the structured web surfaces in section 83 of the total web surfaces of section 83. A proportion of the structured web surfaces in section 83 of the total web surfaces of section 83 is greater than a proportion of the structured web surfaces in section 84 of the total web surfaces of section 84. In FIG. 11, the section 81 has a horizontal oval shape and is arranged centrally in the active region 18. The section 82 encloses the section 81, the section 83 encloses the section 82, the section 84 encloses the section 83. The section 70 is arranged on the right and left edges of the active region 18. In FIG. 12, section 81 is located in the top right corner of active region 18. This is followed by section 82, followed by sections 83, 84 and 70, resulting in a gradual progression from top left to bottom right. Electrical conductivity in the first section 81 is greater than in the second section 82, electrical conductivity in the section 82 is greater than in the section 83, electrical conductivity in the section 83 is greater than in the section 84, electrical conductivity in the section 84 is greater than in the section 70. The uneven arrangement of the proportions of the structured web surfaces can thus homogenize a current density.

FIG. 13 shows a schematic representation of a section of an example separator plate 2a or 2b in the system of FIG. 1 or FIG. 2. The webs 41 and channels 42 are each formed in one piece with the separator plates 2a, 2b and molded into the separator plates 2a, 2b, e.g. via an embossing, hydroforming or deep-drawing process. The same may apply to the corresponding guiding structures of the second separator plates 2b. The guiding structures of the flow field may include a large number of webs 41 and channels 42 formed between the webs 41 in the electrochemically active region 18 and a plurality of webs and, if applicable, channels formed between the webs in the distribution and collection region 20. The webs 41 on the gas side form channels on the coolant side, and channels 42 on the gas side form webs on the coolant side. In the case of bipolar plates formed from only one separator plate, the webs 41 on the first side form channels on the second side, channels 42 on the first side form webs on the second side. The surface structures 38 are arranged on some of the webs 41. The orientation of the surface structures 38 relative to the direction in which the webs or channels extend is only an example. The surface structure 38 of the web region is arranged symmetrically to the virtual center line in the present case but can also be arranged asymmetrically in other examples. As can be seen in FIG. 13, when viewed in cross-section, the two left-hand webs 41 are only structured in a central region between the inflection points, which represent the delimitation to the adjoining channel; in an installed bipolar plate 2 these regions correspond to the structured contact surfaces 80′. Differing therefrom, the right-hand web 41 is provided with the surface structure 38 over considerably wider regions, with the structured web regions 80 essentially corresponding to the area of the entire web 41. When installed, structured web regions 80 can extend further than the regions that form the contact or contact surfaces explained below. Those section of the structured web regions 80 that form the contact areas or contact surfaces also represent structured contact surfaces 80′.

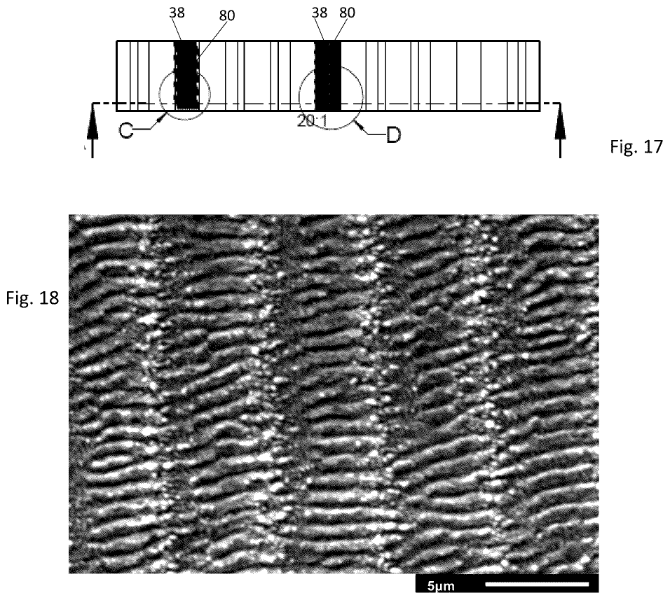

FIG. 14 shows a microscopic image of example periodic surface structures 38 in plan view. FIG. 18 shows another microscopic image of example periodic surface structures 38 in plan view. The periodic surface structures 38 comprise a large number of depressions and protrusions. The depressions run between the protrusions and are limited and/or formed by them. The surface structures 38 are arranged periodically with respect to one another in at least one spatial direction x, y. For instance, the surface structures 38 may be aligned with one another along their longitudinal direction. For example, the surface structures 38, i.e. the depressions and the protrusions, run essentially parallel to each other. For example, the surface structures 38 may be arranged parallel to one another. FIG. 15 and FIG. 16 show details A and B of FIG. 13. FIG. 17 shows a plan view of the section in FIG. 13. Different surface structures are visualized as examples. The same or different surface structures 38 can be formed on a separator plate. For example, it can be seen in FIG. 15 and FIG. 16 that the surface structures 38 are arranged parallel to one another, i.e. perpendicular to the direction in which the surface structures extend. Furthermore, FIG. 15 indicates that surface structures 38 are also arranged parallel to each other and one behind the other in groups (one after the other in the direction of web extension). The surface structures 38 may extend, for example, in a wavy or linear manner along their longitudinal direction. FIG. 16 presents one example of the surface structures 38 extending in a wavy manner.

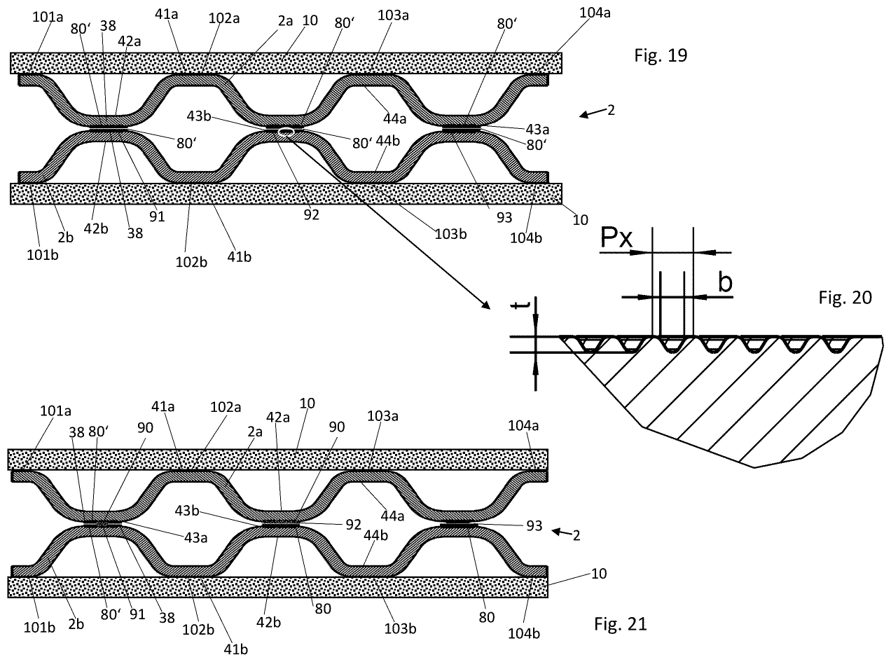

FIG. 19 shows a section of an example bipolar plate 2 in the system of FIG. 1 with a first separator plate 2a and a second separator plate 2b arranged thereon. The first separator plate 2a and the second separator plate 2b touch each other at contact surfaces 91, 92, 93. The contact surfaces 91, 92, 93 are centered on webs of the respective coolant side of the respective separator plate 2a or 2b. An MEA is arranged on each of the gas sides of the separator plates 2a and 2b, allowing the webs 41 of the gas sides to form contact surfaces 101, 102, 103, 104 with the MEA 10. The contact surfaces on the gas side of the separator plate 2a are indicated by the index a and the contact surfaces on the gas side of the separator plate 2b are indicated by the index b.

Surface structures 38 are arranged on both sides of the contact surfaces 91, 92, 93, i.e. on the separator plate 2a and on the separator plate 2b. Additionally or alternatively, surface structures 38 can be applied to webs of the gas side, for example to some of the contact surfaces 101a, 102a, 103a, 104a, 101b, 102b, 103b and/or 104b.

FIG. 20 shows a detail of FIG. 19. It indicates a depth t, a width b and a period Px of the surface structures 38, for example, the depressions. The surface structures 38 may have a depth t of at least 8 nm, optionally at least 50 nm, and/or at most 3 μm, optionally at most 1 μm, optionally at most 500 nm and/or at most 300 nm and/or at most 250 nm. In the present example, the depth is, for example, t=0.4 μm or t=100 nm. In one exemplary embodiment, the surface structures 38 have a width b of at least 0.1 μm and/or at most 2 μm. In the present example, the width is b=0.45 μm. In addition, the surface structures 38 may have a period Px in one spatial direction x of at least 0.3 μm and/or at most 3 μm. In the present example, the period is 1 μm. In FIG. 20, the period Px indicates the lateral distance between two adjacent protrusions.

Due to the surface structures 38, the surface of the separator plate 2a, 2b has chemical, electrical and/or mechanical properties that differ from regions of the separator plate 2a, 2b without surface structures 38, such as the sections 70, 71. For example, as a result of the surface structures 38, an oxygen content of the surface material of the separator plate 2a, 2b may be greater in the region of the periodic surface structures 38 than outside of the periodic surface structures 38.

FIG. 21 illustrates a schematic representation of a portion of an additional exemplary bipolar plate 2 of the system of FIG. 1 with a first separator plate 2a and a second separator plate 2b arranged thereon. The first separator plate 2a and the second separator plate 2b touch each other at contact surfaces 91, 92, 93. The contact surfaces 91, 92, 93 are centered on webs of the respective coolant side of the respective separator plate 2a or 2b. A MEA is arranged on each of the gas sides of the separator plates 2a and 2b, so that the webs 41 of the gas sides form contact surfaces 101, 102, 103, 104 with the MEA 10. The contact surfaces on the gas side of the separator plate 2a are indicated by the index a and the contact surfaces on the gas side of the separator plate 2b are indicated by the index b.

Surface structures 38 are arranged on the contact surfaces 91, 92, 93, i.e. structured contact surfaces 80′ are formed. A surface structure 38 is applied to both the web of the first separator plate 2a and the web of the second separator plate 2b on the contact surface 91. In addition, a coating 90 is applied to at least one of the two surface structures 38. Coating 90 is described in more detail below. At the contact surface 92, a coating 90 is applied to the web of the first separator plate 2a and a surface structure 38 is applied to the web of the second separator plate 2b. Neither a coating 90 nor a surface structure 38 is applied to the web of the first separator plate 2a on the contact surface 93. A surface structure 38 is applied to the web of the second separator plate 2b.

Additionally or alternatively, surface structures 38 and/or coatings may be applied to webs on the gas side, particularly to some of the contact surfaces 101a, 102a, 103a, 104a, 101b, 102b, 103b and/or 104b.

The coating 90 can be provided to increase the electrical conductivity and/or corrosion resistance of the separator plate 2a, 2b. The coating 90 can be applied over the entire surface or in sections. Optionally, at least some of the regions provided with the periodic surface structures 38 are provided with the coating, optionally with a coating that increases electrical conductivity. In one embodiment, the coating 90 can be provided only in the region of the webs and be omitted in the region of the channels. The coating 90 may, for example, comprise one or more of the following substances or consist of one or more of these substances or alloys thereof: electrically conductive oxides, carbon, optionally electrically conductive carbon layers such as graphite, precious metals such as Au, Ag or Pt, metals such as Ti or Cr, metal nitrides or metal oxynitrides such as TiN, TiON (with varying oxygen/nitrogen ratio), CrN, Cr₂N, metal carbides, metal borides, metal silicides and/or silicon carbide. Surface structures 38 and coatings 90 are known, for example, from DE 10 2021 202 214 A1, the content of which is hereby incorporated in full into the present document by reference.

1. A bipolar plate for an electrochemical system, having a first separator plate and a second separator plate that are arranged one on top of the other, wherein
the first separator plate has, on a side facing away from the second separator plate, embossed webs and channels to guide a first fluid;
the second separator plate has, on a side facing away from the first separator plate, embossed webs and channels to guide a second fluid;
the first separator plate and the second separator plate each have on their mutually facing sides webs and channels to guide a cooling medium along an inner side of the bipolar plate;
wherein at least one of the first separator plate and the second separator plate has structured web regions on at least one side of the respective separator plate, wherein the structured web regions at least have periodic surface structures with an average spatial period of less than 10 μm,
whereby a proportion of the structured web regions in a total web surface is distributed heterogeneously over the total web surface.

2. The bipolar plate according to claim 1,
wherein the proportion of the structured web regions is formed on the side of the first separator plate that faces the second separator plate and/or
wherein the proportion of the structured web regions is formed on the side of the second separator plate that faces the first separator plate and/or
wherein the proportion of the structured web regions is formed on the side of the first separator plate that faces away from the second separator plate and/or
wherein the proportion of the structured web regions is formed on the side of the second separator plate that faces away from the first separator plate.

3. A bipolar plate for an electrochemical system, comprising a first separator plate, wherein
the first separator plate has, on a first side, embossed webs and channels to guide a first fluid;
the first separator plate has, on a second side, embossed webs and channels to guide a second fluid;
wherein the first separator plate has structured web regions on at least one side of the first separator plate, wherein the structured web regions have, at least partly, periodic surface structures with a mean spatial period of less than 10 μm,
wherein a proportion of the structured web regions in a total web area is distributed heterogeneously over the total web area.

4. The bipolar plate according to claim 1, wherein the first separator plate has a first electrochemically active region and the second separator plate has a second electrochemically active region, wherein the first electrochemically active region and the second electrochemically active region overlap one another and form an active region of the bipolar plate in an overlapping region, wherein the structured web regions in the active region are located on at least one side of at least one of the first separator plate and the second separator plate.

5. The bipolar plate according to claim 1, wherein the first separator plate and/or the second separator plate form(s) at least one contact area or contact surface, between one another and/or to another component, wherein the periodic surface structures are formed in the at least one contact area or the contact surface, and wherein the periodic surface structures are distributed heterogeneously over the at least one contact area or the contact surface.

6. The bipolar plate according to claim 5, wherein the first separator plate has, in an electrochemically active region of at least one side of the first separator plate, a first region, a second region and a third region,
wherein the periodic surface structures are distributed in such a way that a first proportion of the structured web regions in the first region over a total web surface of the first region is less than a second proportion of the structured web regions in the second region over a total web surface of the second region and/or a third proportion of the structured web regions in the third region over a total web surface of the third region is less than the second proportion and/or the first proportion,
and/or
wherein the periodic surface structures are distributed in such a way that a fourth proportion of the at least one contact area or the contact surface with the periodic surface structures in the first region of a total contact surface of the first region is less than a fifth proportion of the at least one contact area or the contact surface with the periodic surface structures in the second region of a total contact surface of the second region and/or a sixth proportion of the at least one contact area or the contact surface with the periodic surface structures in the third region of a total contact surface of the third region is less than the fifth proportion and/or the fourth proportion.

7. The bipolar plate according to claim 5, wherein the second separator plate has a first region, a second region and a third region in an electrochemically active region of at least one side of the second separator plate,
wherein the periodic surface structures are distributed in such a way that a seventh proportion of the structured web regions in the first region of a total web surface of the first region is less than an eighth proportion of the structured web regions in the second region of a total web surface of the second region and/or a ninth proportion of the structured web regions in the third region of a total web surface of the third region is less than the eighth proportion and/or the seventh proportion,
and/or
wherein the periodic surface structures are distributed such that a tenth proportion of the at least one contact area of the contact surface with the periodic surface structures in the first region is less than a eleventh proportion of the at least one contact area or the contact surface with the periodic surface structures in the second region and/or a twelfth proportion of the at least one contact area or the contact surface with the periodic surface structures in the third region is less than the eleventh proportion and/or the tenth proportion.

8. The bipolar plate according to claim 6, wherein a first ratio of the first proportion to the second proportion is less than 0.9,
and/or
wherein a second ratio of the fourth proportion to the fifth proportion is less than 0.9,
and/or
wherein a third ratio of the third proportion to the second proportion is less than 0.9,
and/or
wherein a fourth ratio of the sixth proportion to the fifth proportion is less than 0.9.

9. The bipolar plate according to claim 6,
at least one side of the first separator plate is configured such that the proportion of the structured web regions over the total web surface and/or a proportion of the at least one contact area or the contact surface with the periodic surface structures over the total contact surfaces of the first region and/or the second region and/or the third region of the first electrochemically active region differ from one another by more than 5%.

10. The bipolar plate according to claim 7,
wherein the second separator plate is configured such that the proportion of the structured web regions over the total web surface and/or a proportion of the at least one contact area or the contact surface with the periodic surface structures over the total contact surfaces of the first region and/or the second region and/or the third region of the second electrochemically active region differ from one another by more than 5%.

11. The bipolar plate according to claim 9, wherein only the second region has the periodic surface structures.

12. The bipolar plate according to claim 1, wherein the bipolar plate is configured to be operated at a certain operating point of an electrochemical system, wherein the certain operating point comprises a specific concentration gradient of the first fluid along a first electrochemically active region,
wherein a surface structure pattern is adapted to the specific concentration gradient of the first fluid, so that a proportion of the structured web regions in sections of an active region with comparatively low concentration of the first fluid is greater than a proportion of the structured web regions in sections of the active region with comparatively high concentration of the first fluid.

13. The bipolar plate according to claim 4, wherein the first separator plate comprises a first inlet opening to supply the first fluid and a first outlet opening to discharge the first fluid,
wherein the first inlet opening is fluidically connected to the first electrochemically active region via a first inlet region and the first outlet opening is fluidically connected to the first electrochemically active region via a first outlet region, so that the first fluid can be conducted successively through the first inlet region, the first electrochemically active region and the first outlet region.

14. The bipolar plate according to claim 8, wherein the second region is arranged closer to an outlet opening than the first region and the third region.

15. The bipolar plate according to claim 1, configured such that a flow direction of the first fluid is opposite to a flow direction of the second fluid, wherein a proportion of the structured web regions of at least one side of a separator plate increases, at least in sections, along the flow direction of the first fluid.

16. The bipolar plate according to claim 1, wherein at least one of the first separator plate and the second separator plate of the bipolar plate consists of a stainless steel or a titanium alloy.

17. The bipolar plate according to claim 1, wherein at least regions having the periodic surface structures are provided, at least in sections, with a coating which increases electrical conductivity.

18. The bipolar plate according to claim 17, wherein the coating contains one or more of the following substances: electrically conductive oxides, carbon, electrically conductive carbon layers, precious metals, metals, metal nitrides, metal oxynitrides, metal carbides, metal borides, metal silicides and/or silicon carbide, wherein the coating is single-layered or multilayered.

19. Electrochemical system comprising multiple bipolar plates according to claim 1.

20. A method for producing a bipolar plate according to one of claim 1, comprising the steps of:
providing the first separator plate and the second separator plate,
irradiating the first separator plate and/or the second separator plate using a pulsed laser, wherein a pulse duration of the laser pulses is less than 1 ns,
generating periodic surface structures on the first separator plate and/or the second separator plate by means of laser radiation,
wherein a proportion of the structured web regions over the total web surface is distributed heterogeneously over the total web surface.
